(19) United States
(12) Patent Application Publication
(10) Pub. No.: US 2007/0152440 A1
(43) Pub. Date: Jul. 5, 2007

(54) Pipe sealing system

(76) Inventor: Thomas Joseph Keyes, Fort Worth, TX (US)

Correspondence Address: Charles D. Gunter, Jr.;Whitaker, Chalk, Swindle & Sawyer, LLP, Suite 3500, 301 Commerce Street, Fort Worth, TX, 76102-4186, US

(21) Appl. No.: 11/322,778

(22) Filed: Dec. 30, 2005

(51) Int. Cl. F16L 55/00

(52) U.S. Cl. 285/45

(57) ABSTRACT

A sealing system is used for sealing entry ports of piping into the sidewalls of structures. The system is designed to receive a length of insulated piping and seals the piping against liquid intrusion. The system can also compensate, where necessary, for the expansion and contraction which occurs as these systems thermally expand in the presence of high temperature fluids being conveyed or due to other forces. The system uses a flexible bellows to couple the insulated piping to a liner sleeve located in a porthole opening of the structure. The bellows arrangement not only seals against liquid intrusion, but also compensates for any relative movement of the inner fluid conveying pipes with respect to the liner sleeve of the structure. A flexible strut system may also be used within the interior of the structure to join pipe ends and further compensate for forces of expansion and contraction.

### BACKGROUND OF THE INVENTION

1. Field of the Invention

The present invention relates to sealing systems for sealing entry ports of piping into above and below ground buildings and structures including, by way of example, building walls and the walls of concrete manholes.

2. Description of the Prior Art

There are various examples in the prior art of the need for pipe sealing systems for sealing the entry ports of piping into, for instance, a concrete wall. The wall might be a structural wall or foundation wall of a residential, commercial or industrial building or structure. Another common example is in the area of concrete manholes, valve pits and the like, in which conduits enter and leave the manhole and are required to be sealed at the “porthole” or point of entry of the conduit into a sidewall or riser section of the manhole. In the case of underground sewer and manhole construction, the manholes may receive sewer pipe lines in such installations at different levels and at different angles of approach.

In addition to the typical water and sewage manhole installations discussed above, there are many instances in which insulated pipelines are needed For example, distributed HVAC (heating, ventilation and air conditioning) applications utilize chilled water for cooling and steam for heating. The chiller and boiler are typically contained in a central location and the chilled water and steam are distributed to other locations. For example, on a school campus, the chiller and boiler may be located in a power plant building. The chilled water and steam are distributed to classrooms in separate buildings. A set of insulated pipelines is used to convey the chilled water from the chiller to other locations and back to the chiller. Another set of insulated pipelines is used to carry the steam from the boiler to the other locations and back to the boiler. The insulated pipelines are usually located underground and must enter the various building sidewalls or foundation walls (typically formed of concrete) at an entry port.

Insulated pipe is conventional and commercially available. There are predominately two types of piping systems in use: Class-A drainable dryable testable (DDT); and polyurethane or polyisocyanurate bonded foam systems. One particularly preferred form of the application of the present invention is directed toward the bonded foam type system. These systems utilize an inner carrier pipe to convey fluid. Around the outside of the carrier pipe is a layer of insulating foam such as, for example, polyisocyanurate foam. Around the outside of the foam is a jacket of hard thermoplastic (such as high density polyethylene, HDPE). The plastic jacket protects the foam from mechanical damage and also provides a water tight seal to prevent corrosion of the carrier pipe. Although steel is commonly used for the inner pipe which carries the media to be piped, copper or aluminum or other metals as well as fiberglass, PVC, and similar materials may be utilized, as well.

While the invention has particular application to such pre-insulated, bonded foam type systems, the sealing system of the invention can also be applied to other insulated piping systems such as, for example, the Pure Class A and Modified Class A Steel Conduit Systems, as they are referred to in the industry.

For simplicity sake, the field of the present invention will be described in terms of the sealing systems used with concrete manhole and valve pit installations. Insulated pipeline installations of the type described typically include one or more manholes, or valve pits, which are typically formed of cast concrete and which have portholes for receiving the piping. The portholes must also be sealed against fluid leakage. A typical underground pipeline includes a trench which may be dug to a level well below the frost line and well below ground level. Fitting of pipes into manholes and forming a reliable seal has been difficult in many instances. Although a number of systems are commercially available for use in this situations, the available sealing technology has presented certain problems and shortcomings.

For example, at the present time, a Century Line Sleeve® can be cast into the wall of the concrete manhole. It is a generally cylindrical sleeve formed of a polyolefin material, such as high density polyethylene, which lines the “porthole” in the wall of the concrete valve pit or manhole and which receives the section of the piping entering the interior of the manhole. A Link-Seal® is one type of sealing system which is then used to form the seal between the piping and the Line Sleeve®. Both items are commercially available from Thunderline/Link-Seal of Houston, Tex. The Link-Seal® is a modular, mechanical type of seal, consisting of inter-locking synthetic rubber links shaped to continuously fill the annular space between the pipe and the wall opening containing the Line Sleeve®. To install the Link-Seal®, it was necessary to properly place the assembly around the pipe in the manhole opening and then tighten a series of circumferentially arranged bolts, which action caused the seal structure to “bulge outwardly” and make sealing contact with the porthole opening. While the Link-Seal® has worked satisfactorily in many instances, it is somewhat dimension critical by its nature and complicated in design. Because the Link-Seal® itself occupies a fairly large circumferential area or region about the exterior of the pipe being sealed, it necessarily requires a larger diameter port hole in the sidewall of the manhole than otherwise might be necessary.

Other types of flexible couplings have also been disclosed in the prior art for purposes of connecting misaligned plumbing for liquids or gas, for shock absorption, and for providing flexibility when the connections to which the couplings are attached are not originally fixed with respect to each other. For example, in earthquake prone areas, it may be desirable to provide flexible couplings in plastic waterline systems. In the case of high temperature or high pressure systems, more complicated bellows-type systems have been employed. For example, U.S. Pat. No. 4,239,267 shows an expansion joint which features an internal bellows member within a special steel housing. U.S. Pat. Nos. 5,248,170 and 5,299,840, both show bellows type expansion joints with gimbal ring connecting assemblies which are used in the chemical, oil and power industries to compensate for thermal expansion, pressure differentials and lateral movement. U.S. Pat. No. 3,488,949 shows a piping system which includes three separate bellows having two floating piping sections surrounded by a wrapper plate for use in piping systems subjected to both thermal and pressure stresses.

Despite these advances, a need exists for an improved sealing system for use within a variety of types of piping for sealing the piping within an entry port in a building wall or other structural wall.

A need also exists for an improved sealing and expansion installation in a piping system for high temperature fluids such as insulated steam line which is less complex than the high temperature and pressure installations discussed above.

A need also exists for such a system which more effectively seals piping within the porthole of a concrete manhole or valve pit than did the prior art sealing systems and which more readily accommodates expansion and contraction forces in the pipeline than did the prior art systems.

A need also exists for such an installation system which utilizes many of the conventionally available materials and manufacturing techniques commonly used in the industry and which is relatively simple in design and economical to implement.

### SUMMARY OF THE INVENTION

The present invention has as its general object to provide a sealing system for a piping system, such as for example, a high temperature line expansion installation, which satisfies the previously described deficiencies in the prior art systems.

Another object of the invention is to provide such a sealing system which includes a bellows arrangement in combination with other specific materials to provide a flexible coupling at the point at which a pipeline enters a manhole or valve pit and which compensates, where necessary, for the tendency of the pipeline to move under the influence of expansion and contraction forces.

The sealing system of the invention is used with a structure having at least one porthole opening defined between opposing wall openings for receiving piping extending from a point exterior of the structure to an interior space thereof. The system includes a liner sleeve formed of a synthetic polyolefin located within and lining the porthole opening of the structure. The liner sleeve comprises a generally cylindrical body having opposing end regions which initially extend outwardly slightly from the opposing wall openings of the porthole. A length of insulated and jacketed piping passes through the liner sleeve from outside the structure to the interior space thereof. In one preferred embodiment, the length of piping comprises an inner steel carrier pipe, an envelope of high temperature foamed insulation surrounding the inner pipe and an outer polyolefin protective jacket surrounding the envelope of insulation. The piping preferably forms section of a continuous fluid conduit for conveying high temperature fluids.

A flexible tubular bellows surrounds and joins one point of the outer polyolefin protective jacket of the length of insulated and jacketed piping to a second point on a selected end region of the liner sleeve which extends from the wall opening of the structure to the exterior thereof. The bellows is capable of being axially expanded and contracted to accommodate movement of the insulated and jacketed piping where expansion and contraction forces are present. The tubular bellows can be joined by any convenient technique, such as by being electrofused at either of opposite extents thereof to the respective protective jacket and liner sleeve. Preferably, the foam insulation is selected from the group consisting of polyurethane foams and polyisocyanurate foam. One preferred material for the outer protective jacket of the piping is high density polyethylene.

In a further embodiment of the invention, the length of insulated and jacketed piping which passes into the interior space of the structure terminates in a pipe end. The pipe end is connected to a pipe end of an additional length of piping or to a valve member by means of a flexible strut joint which absorbs expansion and contraction forces in the structure. The flexible strut joint is preferably a ball and socket construction which is capable of resisting tensile and compressive loads while allowing lateral, angular and rotational movement of the respective lengths of piping.

Additional objects, features and advantages will be apparent in the written description which follows.

### BRIEF DESCRIPTION OF THE DRAWINGS

FIG. 1 is a simplified representation of a typical distributed HVAC system of the type which might utilize chilled water for cooling and steam for heating.

FIG. 2 is a partial sectional view of a section of piping showing typical manhole or valve pit placement along the pipeline.

FIG. 3 is a cross sectional view of one form of the sealing system of the invention showing a section of pipeline entering a porthole opening in a concrete manhole.

FIG. 4 is a simplified view of the valve pit showing the sealing system of FIG. 3 in place in the porthole of the manhole.

FIG. 5 is a simplified view of another embodiment of the sealing system of the invention in which the pipe end section entering the manhole interior are provided with flexible expansion joints.

FIG. 6 is a schematic view of a prior art piping system showing the expansion loops located therein.

FIG. 7 is a view similar to FIG. 6, but showing the elimination of the expansion loops through the use of the flexible pipe joints of the system of the invention.

### DETAILED DESCRIPTION OF THE INVENTION

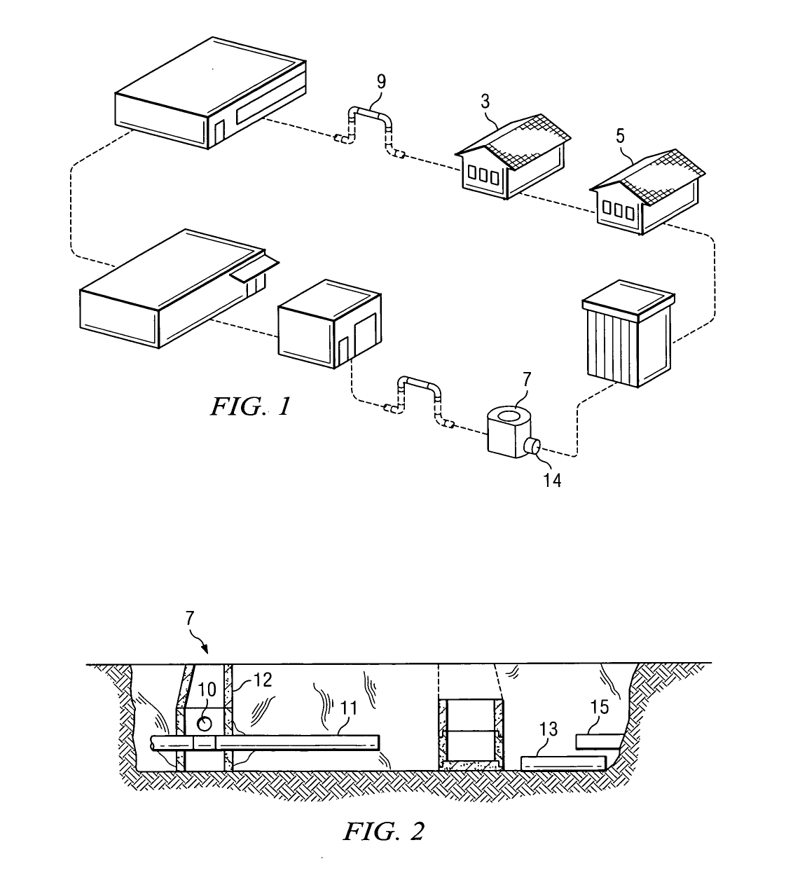

Turning first to FIGS. 1-2, there is illustrated a typical environment in which the pre-insulated piping systems of the invention might be employed. FIG. 1 shows a school campus having a number of isolated buildings 3, 5 connected by an underground insulated pipeline carrying steam which at points includes right angle loops or elbows 9. The loops 9 are provided in a typical piping system of the type illustrated in order to compensate for expansion and contraction forces which are exerted on the piping. The piping system will also typically include one or more manholes or “valve pits” 7 and these terms are used generally interchangeably in the discussion which follows. The manholes 7 are typically formed of cast concrete and include portholes (10 in FIG. 2) and riser sections 12.

As will be appreciated by those skilled in the art, the sealing systems of the invention could be used with a variety of types of pipes and pipe installations. Generally speaking, any structural porthole equipped with a polyolefin type liner or “sleeve” could accept the sealing system of the invention. For simplicity, the invention is first described in relation to a concrete valve pit used in an insulated steam piping system.

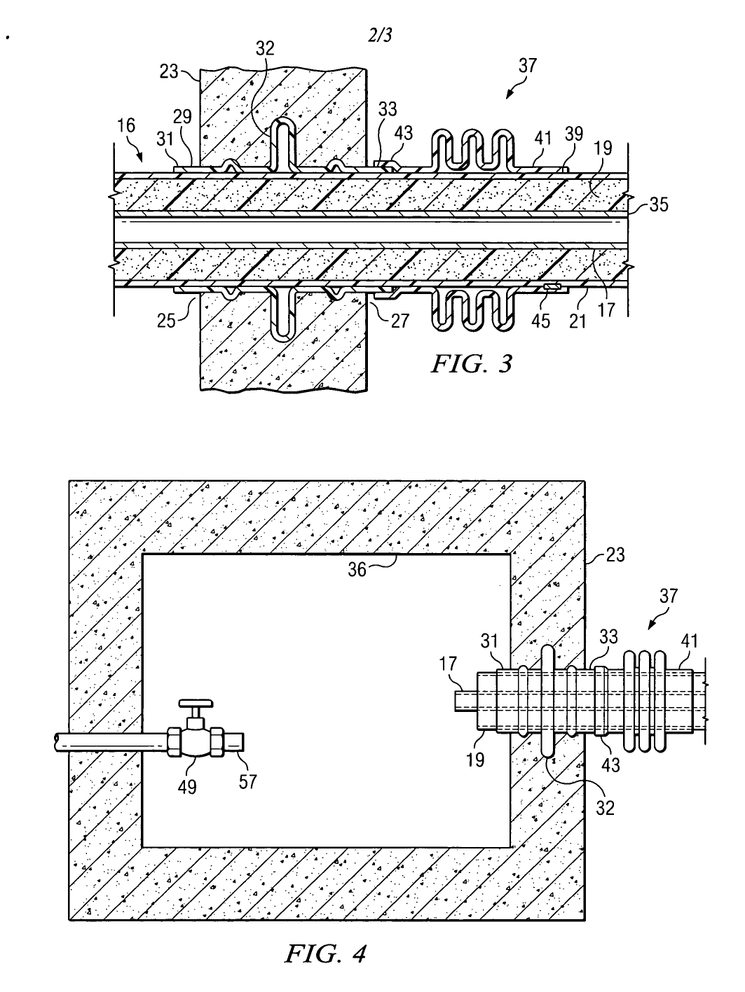

FIG. 2 is a somewhat simplified view of a typical underground piping system of the type under consideration in which pipe sections 11, 13 and 15 are located in generally parallel underground planes and which are intended to intersect previously located manhole portholes 10. As perhaps best seen in FIG. 3, the pipe sections, such as the section illustrated at FIG. 16, are foam bonded pre-insulated piping sections, as that term is used in the relevant art. Each length of pipe includes an inner pipe 17, typically formed of steel, an envelope of foamed insulation 19 surrounding the inner pipe and outer protective jacket 21 surrounding the envelope of insulation. The joining ends of the adjacent steel inner carrier pipe (e.g., end 35 in FIG. 3) are affixed, as by being welded together, to form fixed joints, whereby the adjacent pipe lengths provide a continuous fluid conduit for conveying high temperature fluids. The jacket 21 (FIG. 3) is typically formed of high density polyethylene (HDPE) or a similar polyolefin type material. The following references, among others, teach the manufacture of prior art insulated piping systems of the general type under consideration:
U.S. Pat. Nos. 3,793,411; 4,084,842; and 4,221,405, all to Stonitsch et al.

The piping systems of the type illustrated in the drawings are typically utilized to convey fluids at high temperature and/or pressures. For example, a typical steam line might be conveying fluid at, for example, 400° F. The temperature differentials which exists between the piping system materials and the fluid being conveyed cause expansion and contraction forces to be applied along the coaxially aligned pipe lengths. The bonded foam piping system illustrated in FIG. 3 is intended to move as a unit as expansion and contraction forces are experienced. If the inner carrier pipe 17 were to move independently of the outer foam insulation 19, the two would tend to separate, forming a possible failure point which would allow the intrusion of water or other contaminants into the system.

The expansion and contraction forces are partially compensated for in the prior art by including one or more expansion loops (illustrated at 9 in FIG. 1). However, at the porthole opening (10 in FIG. 2) of the concrete manhole, it was generally necessary to place an anchor (14 in FIG. 1) since the sealed porthole did not allow for longitudinal movement of the piping. Various other techniques were also used to compensate for expansion and contraction forces along the length of the pipeline. For example, cushioned bolster padding (not shown) was sometimes placed in the surrounding soil, as at turns in direction in the pipeline.

The present invention, in its most preferred form, is directed toward a sealing and expansion installation for high temperature insulated piping systems of the type previously described. The present invention attempts to alleviate, to some extent, the possible disbondment problems for foam bonded piping systems that are operating at “high temperature” in the range of 250° F. and above 250° F. The invention is also directed to an improved seal system and seal structure for sealing a length of foam bonded pre-insulated piping of the type described at the porthole opening of a concrete manhole or valve pit. The expansion and sealing system of the invention also provides an improved structure for accommodating the joining of adjacent pipe ends in the manhole interior to better compensate for expansion and contraction forces acting on the pipeline.

The reference in this discussion to pipe “lengths” is intended to refer to standard available factory pre-insulated piping of the type previously described having an inner metal pipe surrounded by an envelope of foamed insulation, which in turn, is contained within a polyolefin jacket. As referred to briefly above, typical commercial practice involves the use of steel, copper, aluminum or alloy conveying pipes, open or closed cell polyurethane, polyisocyanurate, polystyrene or the like, foamed rigid insulation and polypropylene, polybutylene, polyethylene, polyvinylchloride and similar protective jackets.

The term “high temperature”, as used in this discussion, will be any temperature exceeding 250° F., which is the present temperature limitation at which polyurethane foam is used in bonded foam systems. Temperatures above 250° F. require the use of higher temperature foams, such as polyisocyanurate foam.

The present invention is an improvement to presently available pre-insulated piping of the type which is commercially available and familiar to those in the relevant industries. Prior art pipe lengths of this general type are commercially available as standard factory type product. For example, such product is available from Thermacor Process, LP of Fort Worth, Tex., assignee of the present invention. One typical example is sold commercially as the “HT-406 High Temp Steel Piping System™.”

As will be appreciated, in the discussion which follows, the sealing systems of the invention can be used advantageously with the “HT-406 High Temp Steel Piping System™”, since the sealing system can not only seal the piping within the porthole of entry into the associated structure, but also can accommodate for expansion and contraction forces which might otherwise act to adversely affect the structural integrity of the insulated piping. However, the sealing system can also be used with other commercial piping systems used in the insulated pipe industries, such as for example, Applicant's Pure Class A Steel Conduit System™, Applicant's Duo-Therm 505 Modified High Density Polyethylene Jacketed Class A Steel Conduit System™, etc. In other words, the unique sealing aspects of Applicant's systems may be used in applications even where expansion and contraction forces are not necessarily intended to be accommodated for by the sealing system itself. However, the systems of the invention offer particular utility in situations where the insulated pipelines are subject to expansion and contraction forces which must be controlled at the point of entry into the building or structural sidewall.

Thus, with reference to FIG. 3, the length of insulated and jacketed piping illustrated for a preferred form of the invention (designed generally as 16 in FIG. 3) includes an inner steel carrier sleeve 17, an envelope of high temperature foamed insulation 19 surrounding the inner pipe, and an outer polyolefin protective jacket 21 surrounding the envelope of insulation 19. In the particular embodiment of the invention illustrated in FIG. 3, the surrounding foam insulation layer 19 is typically polyurethane closed cell foam insulation for systems of up to about 250° F. and polyisocyanurate foam insulation for systems above 250° F. The piping 16 forms a section of continuous fluid conduit for conveying high temperature fluids. The present invention is a sealing and expansion system for sealing the piping 16 within the porthole (10 in FIG. 2) of the precast concrete valve pit 7 where the porthole 10 is defined between opposing wall openings in the valve pit and is sized for receiving piping extending from a point exterior of the valve pit to an interior space thereof.

As shown in FIG. 3, the concrete manhole riser section 23 has inner and outer wall openings 25, 27 which define the porthole there between. A liner sleeve 29 is located within and lines the porthole opening of the manhole. The liner sleeve comprises a generally cylindrical body having opposing end regions 31, 33 which initially extend outwardly slightly from the opposing wall openings of the porthole. In the example illustrated in FIG. 3, a Century Line Sleeve® 29 has been cast within the concrete wall 23 and is held in place, at least in part, by the bulge region 32. The Line Sleeve® is formed of a suitable polyolefin, preferably high density polyethylene (HDPE). The length of insulated and jacketed piping 16 passes through the liner sleeve 29 from outside the manhole to the interior space 36 thereof.

A flexible tubular bellows 37 surrounds and joins one point of the end region 33 of the outer polyolefin protective jacket of the length of insulated and jacketed piping to a second point (illustrated as 39 in FIG. 3) on a selected end region of the liner sleeve 21 which extends from the wall opening 10 of the manhole 7 to the exterior thereof. The bellows 37 is formed of a material which is compatible with and capable of being bonded to the outer protective jacket 21 of the insulated and jacketed pipeline 16. In this case, the bellows 37 is formed of HDPE. The bellows is capable of being axially expanded and contracted to accommodate movement of the insulated and jacketed piping. There is no mechanical type sealing structure located between the insulated piping and the liner sleeve, as in the prior art. The dimensional relationship between the insulated pipe O.D. and the liner sleeve I.D. is also not as critical, since the bellows tends to compensate for dimensional differences.

Thus, the tubular bellows has opposing outer extents 41, 43 (FIGS. 3 and 4) which are joined to the respective liner sleeve 29 at one end and the outer jacket 21 at the opposite end in any convenient manner which forms a water tight seal. For example, the outer extent 41 is joined to the jacket 21 of the pipe 16 by means of a commercially available POWERCORE® welding wire (illustrated in simplified fashion as 45 in FIG. 3) which is used to electrofuse the like materials of the bellows and jacket. The same type welding wire package would be used to join the opposing end 31 of the bellows to the pipe outer jacket 21. The outer extent 41 of the bellows surrounds the jacket 21 and resistive wires included as a part of the POWERCORE® package. Upon applying an electric current to the wires, a weld between the bellows and jacket is achieved.

The preferred form of the invention, as has been described, contemplates a liner sleeve for the porthole opening in the structural sidewall formed of a polyolefin material which can be readily fusion bonded to the tubular bellows 37 of the sealing system. However, if the porthole in the sidewall of the structure being sealed is lined, for example, with a steel sleeve, the tubular bellows 37 of Applicant's sealing system could be secured in some alternate fashion. For example, a metal band clamp (not shown) could be placed around the exterior of the bellows 37 and about the exposed end of the steel sleeve in the porthole and tightened down in order to seal the bellows 37 to such a steel porthole liner sleeve. Other types of attachment mechanisms might also be utilized.

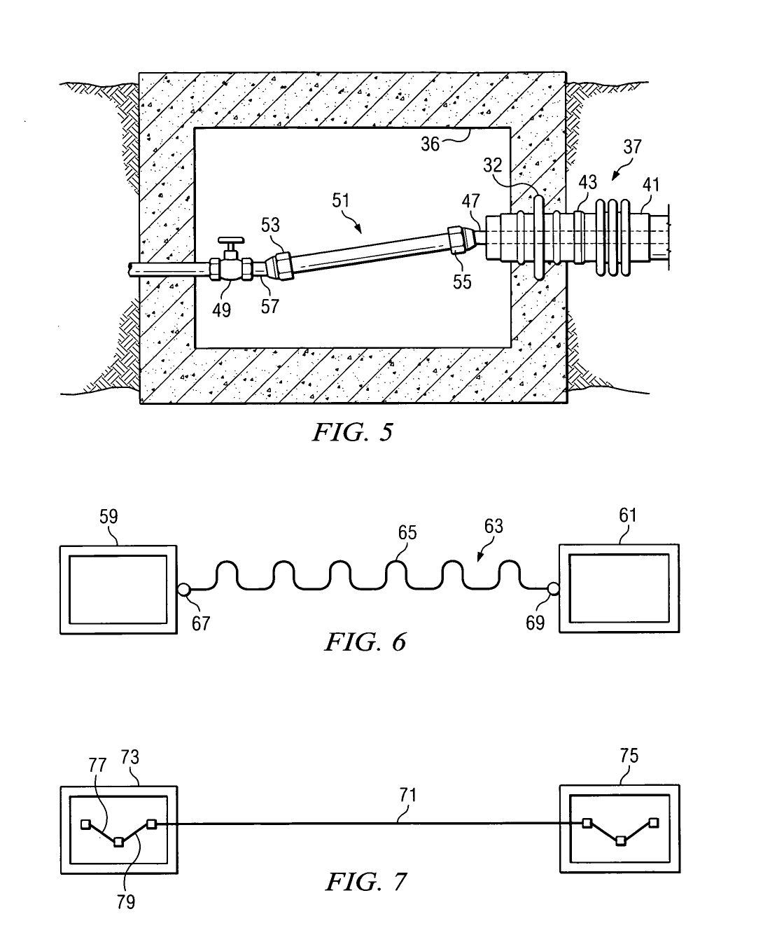

FIG. 5 illustrates another aspect of the invention in which an exposed pipe end 47 of the insulated and jacketed piping 16 which is received within the manhole interior 36 is joined to a valve installation 49 by means of a flexible coupling 51. The particular flexible coupling 51 is, in this instance, a commercially available flexible strut joint which absorbs expansion and contraction forces on the pipes in the manhole. The flexible coupling shown in FIG. 5 is a Hyspan Barco Flexible Strut Joint®. This particular flexible joint provides a rigid structural support capable of resisting high tensile and compressive loads while allowing lateral, angular and rotational movement. It includes a rigid length of tubing having a precision ball and socket joint 53, 55 at either end thereof which has been used in the past for connection to brace piping, pressure vessels, boilers tanks and similar process equipment. It has not, to Applicant's knowledge, been utilized in the field of foam bonded pre-insulated piping, or for manhole sealing systems.

The particular embodiment of the piping system illustrated in FIG. 5 is somewhat schematic in nature. It will be understood by those skilled in the art that several flexible coupling members 51 might be joined end-to-end in order to complete the connection between the pipe ends 47, 57, depending upon the relative height and orientation of the pipe ends being joined.

FIG. 6 is a schematic illustration of a typical piping system connecting manholes 59, 61. The system includes insulated and jacketed piping 63 which is equipped with a number of expansion loops 65. The piping is joined to the manholes 59, 61 by means of anchor points 67, 69.

FIG. 7 is another schematic illustration which shows the new piping system of the invention. In this case, the system includes a generally straight run of jacketed piping 71 passing between manholes 73, 75. There are no anchor points, since the piping 71 is sealed within the manhole porthole openings by the sealing and expansion system of the invention, as illustrated in FIGS. 3 and 5. A pair of flexible couplings 77, 79 in each manhole eliminate the need for anchor points and for expansion loops in the generally straight run of piping.

An invention has been provided with several advantages. The flexible coupling of the invention alleviates problems previously encountered with high temperature piping systems where such systems were subjected to damaging stresses. The system provides a simple and effective sealing system for a variety of piping systems and installations. The system incorporates several existing, commercially available materials or components, thereby simplifying manufacture and assembly. The particular bellows and additional flexible coupling components of the system compensate for expansion and contraction forces which could otherwise damage the integrity of the piping system. There is no need to utilize a mechanical sealing structure between the liner sleeve and the insulated and jacketed piping as was necessary in the prior art techniques. The bellows provides for longitudinal movement of the inner piping. The flexible couplings present in the manhole interior further compensate for expansion and contraction forces and may eliminate or reduce the need for expansion loops and anchor points of the type required in the prior art. The coupling is simple in design and economical to implement in a variety of industrial applications.

While the invention has been shown in one of its forms, it is not thus limited but is susceptible to various changes and modifications without departing from the spirit thereof.

What is claimed is:

1. A sealing system for use with a structure having at least one porthole opening defined between opposing wall openings for receiving piping extending from a point exterior of the structure to an interior space thereof, the sealing system comprising:
a liner sleeve located within and lining the porthole opening of the structure, the liner sleeve comprising a generally cylindrical body having opposing end regions which initially extend outwardly slightly from the opposing wall openings of the porthole;
a length of insulated and jacketed piping passing through the liner sleeve from outside the structure to the interior space thereof, the length of piping comprising an inner steel carrier pipe, an envelope of insulation surrounding the inner pipe and an outer polyolefin protective jacket surrounding the envelope of insulation, the piping forming section of a continuous fluid conduit for conveying high temperature fluids;
a flexible tubular bellows surrounding and joining one point of the outer polyolefin protective jacket of the length of insulated and jacketed piping to a second point on a selected end region of the liner sleeve which extends from the wall opening of the structure to the exterior thereof, the bellows being capable of being axially expanded and contracted to accommodate movement of the insulated and jacketed piping.

2. A sealing and expansion system for use with a concrete manhole having at least one porthole opening defined between opposing wall openings for receiving piping extending from a point exterior of the manhole to an interior space thereof, the sealing and expansion system comprising:
a liner sleeve formed of a synthetic polyolefin located within and lining the porthole opening of the manhole, the liner sleeve comprising a generally cylindrical body having opposing end regions which initially extend outwardly slightly from the opposing wall openings of the porthole;
a length of insulated and jacketed piping passing through the liner sleeve from outside the manhole to the interior space thereof, the length of piping comprising an inner steel carrier pipe, an envelope of high temperature foamed insulation surrounding the inner pipe and an outer polyolefin protective jacket surrounding the envelope of insulation, the piping forming section of a continuous fluid conduit for conveying high temperature fluids;
a flexible tubular bellows surrounding and joining one point of the outer polyolefin protective jacket of the length of insulated and jacketed piping to a second point on a selected end region of the liner sleeve which extends from the wall opening of the manhole to the exterior thereof, the bellows being capable of being axially expanded and contracted to accommodate movement of the insulated and jacketed piping.

3. The system of claim 2, wherein the foam insulation is selected from the group consisting of polyurethane foams and polyisocyanurate foam.

4. The system of claim 2, wherein the protective jackets are formed from polyethylene.

5. The system of claim 2, wherein the tubular bellows is electrofused at either of opposite extents thereof to the respective protective jacket and liner sleeve.

6. The system of claim 2, wherein the lengths of insulated piping being joined are part of a pipeline conveying steam, hot water or other hot fluids at a temperature in the range of above about 200° F.

7. A sealing and expansion system for use with a concrete manhole having at least one porthole opening defined between opposing wall openings for receiving piping extending from a point exterior of the manhole to an interior space thereof, the sealing and expansion system comprising:
a liner sleeve formed of a synthetic polyolefin located within and lining the porthole opening of the manhole, the liner sleeve comprising a generally cylindrical body having opposing end regions which initially extend outwardly slightly from the opposing wall openings of the porthole;
a length of insulated and jacketed piping passing through the liner sleeve from outside the manhole to the interior space thereof, the length of piping comprising an inner steel carrier pipe, an envelope of high temperature foamed insulation surrounding the inner pipe and an outer polyolefin protective jacket surrounding the envelope of insulation, the piping forming section of a continuous fluid conduit for conveying high temperature fluids;
a flexible tubular bellows surrounding and joining one point of the outer polyolefin protective jacket of the length of insulated and jacketed piping to a second point on a selected end region of the liner sleeve which extends from the wall opening of the manhole to the exterior thereof, the bellows being capable of being axially expanded and contracted to accommodate movement of the insulated and jacketed piping;
wherein the length of insulated and jacketed piping which passes into the interior space of the manhole terminates in a pipe end, and wherein the pipe end is connected to a pipe end of an additional length of piping means of a flexible strut joint which absorbs expansion and contraction forces in the manhole.

8. The system of claim 7, wherein the foam insulation is selected from the group consisting of polyurethane foams and polyisocyanurate foam.

9. The system of claim 7, wherein the protective jackets are formed from polyethylene.

10. The system of claim 7, wherein the tubular bellows is electrofused at either of opposite extents thereof to the respective protective jacket and liner sleeve.

11. The system of claim 7, wherein the flexible strut joint is a ball and socket construction which is capable of resisting tensile and compressive loads while allowing lateral, angular and rotational movement of the respective lengths of piping.

12. A method of forming a sealed connection at a concrete manhole having at least one porthole opening defined between opposing wall openings for receiving piping extending from a point exterior of the manhole to an interior space thereof, the method comprising the steps of:
locating a liner sleeve formed of a synthetic polyolefin within and lining the porthole opening of the manhole, the liner sleeve comprising a generally cylindrical body having opposing end regions which initially extend outwardly slightly from the opposing wall openings of the porthole;
passing a length of insulated and jacketed piping through the liner sleeve from outside the manhole to the interior space thereof, the length of piping comprising an inner steel carrier pipe, an envelope of high temperature foamed insulation surrounding the inner pipe and an outer polyolefin protective jacket surrounding the envelope of insulation, the piping forming section of a continuous fluid conduit for conveying high temperature fluids;
providing a flexible tubular bellows surrounding and joining one point of the outer polyolefin protective jacket of the length of insulated and jacketed piping to a second point on a selected end region of the liner sleeve which extends from the wall opening of the manhole to the exterior thereof, the bellows being capable of being axially expanded and contracted to accommodate movement of the insulated and jacketed piping; and
wherein the length of insulated and jacketed piping which passes into the interior space of the manhole terminates in a pipe end, and wherein the pipe end is connected to a pipe end of an additional length of piping means of a flexible strut joint which absorbs expansion and contraction forces in the manhole.

13. The method of claim 12, wherein the foam insulation which is used to surround the inner pipes is selected from the group consisting of polyurethane foam and polyisocyanurate foam.

14. The method of claim 12, wherein the protective jackets are formed of HDPE.

15. The method of claim 12, wherein the tubular bellows is electrofused at either of opposite extents thereof to the respective protective jacket and liner sleeve.

16. The method of claim 12, wherein the lengths of insulated piping being joined are part of a pipeline conveying steam at a temperature of 400 degrees F. or greater.
